(19) United States
(12) Patent Application Publication
(10) Pub. No.: US 2019/0133862 A1
(43) Pub. Date: May 9, 2019

(54) UPPER EXTREMITY SURGICAL PLATFORM

(71) Applicant: Brent Lane Norris, Tulsa, OK (US)

(72) Inventor: Brent Lane Norris, Tulsa, OK (US)

(21) Appl. No.: 16/180,463

(22) Filed: Nov. 5, 2018

Related U.S. Application Data
(60) Provisional application No. 62/582,127, filed on Nov. 6, 2017.

(51) Int. Cl. A61G 13/12; A61G 13/08

(52) U.S. Cl. CPC A61G 13/1235; A61G 13/129; A61G 2210/50; A61G 13/1285; A61G 13/08; A61G 13/122

(57) ABSTRACT

A stable surgical platform table attachment for fixation of upper extremity trauma. The surgical platform assembly may comprise a stable platform for the patient's upper arm. The platform may be attached to a frame assembly, which may be capable of being supported by a surgical peg board. The surgical platform assembly may be radiolucent and height adjustable. The surgical platform assembly may provide an extension platform for the patient's lower arm, where the angle of the extension platform may be easily changed as needed or the entire extension platform easily removed, as desired.

### CROSS REFERENCE

This application is based on and claims priority to U.S. Provisional Application No. 62/582,127 filed Nov. 6, 2017.

### BACKGROUND OF THE INVENTION

### Field of the Description

This invention relates generally to a surgical platform, and more particularly, but not by way of limitation, to a stable surgical platform table attachment for fixation of upper extremity trauma.

### Description of the Related Art

During surgery, a stable surface is important. The patient typically lies on a surgical table, and is positioned according to the area of the patient's body on which the operation will occur, with various supports or other accessories added as needed to provide stability. When a patient requires surgery on the side or back of the upper arm, the patient is typically placed in the prone position. The prone position can be harmful to the patient if they remain in this position for too long. It is better for the patient to be in a lateral position with the arm in question upward. There is not currently, however, a suitable support for the patient's arm that provides a stable surgical platform. Often, a support is improvised for a patient in this position, such as with a pile of blankets. This does not provide a stable surface, however, and can prove problematic for radiographic imaging.

Based on the foregoing, it is desirable to provide a stable surgical platform table attachment to support a patient's upper arm when in a lateral position.

It is further desirable for the surgical platform to fit into existing surgical pegboards and surgical tables.

It is further desirable for the surgical platform to be height adjustable.

It is further desirable for the surgical platform to allow for extension to flex the patient's elbow.

It is further desirable for the surgical platform to be radiolucent

It is further desirable for the angle of the surgical platform to be adjustable.

### SUMMARY OF THE INVENTION

In general, in a first aspect, the invention relates to a surgical platform assembly comprising a platform capable of stably supporting an upper arm of a patient and a frame assembly, where the platform is attached to and stably supported by the frame assembly. The platform may have a flat top and may be radiolucent. The frame assembly may be capable of being stably supported by a surgical peg board, a surgical table clamp, or a surgical table rail, and may be height adjustable.

The frame assembly may comprise two parallel horizontal rails, where the platform rests upon and is attached to and supported in a horizontal position by the two parallel horizontal rails; and two parallel vertical rails, where each of the vertical rails has an upper end connected to a first end of one of the horizontal rails, such that the two parallel horizontal rails and the two parallel vertical rails form two parallel supports. Each of the two parallel horizontal rails and each of the two parallel vertical rails may be generally tubular. The frame assembly may further comprise two nesting rails, where each of the nesting rails fits slidably within and is generally coaxial with one of the vertical rails, such that the nesting rails are capable of sliding in and out of a lower end of the vertical rails and being secured thereto at a desired position to alter the height of the surgical platform assembly. Each of the nesting rails may further comprise a stop located on the nesting rail, where the stop is capable of preventing the nesting rail from sliding fully within its corresponding vertical rail, and a lower end capable of fitting within a hole in a surgical peg board. The frame assembly may further comprise a lateral hole in each of the vertical rails, one or more corresponding lateral holes in each of the nesting rails, and two pegs, where each peg is capable of being inserted through the hole in one of the vertical rails and through one of the holes in one of the nesting rails to secure the nesting rail in a particular position relative to the vertical rail.

The surgical platform assembly may further comprise a horizontal support extending between the two parallel vertical rails. The surgical platform assembly may further comprise a sternal chest plate mounted on the horizontal support, and may further comprise a plurality of mounting points for removably mounting the sternal chest plate to the horizontal support in a desired position.

The surgical platform assembly may further comprise an extension platform capable of stably supporting a lower arm of the patient, where the extension platform is attached to and stably supported by the frame assembly. The frame assembly may comprise one or more hinges capable of altering the angle of the extension platform relative to the platform. The extension platform may be removable, and may be radiolucent.

The surgical platform assembly may further comprise one or more pads. The pads may be removable, disposable, and intended for one-time use.

### BRIEF DESCRIPTION OF THE DRAWINGS

FIG. 1 is a partially exploded front perspective view of the surgical platform;

FIG. 2 is a partially exploded front perspective view of the surgical platform, from a different perspective and showing different exploded elements than FIG. 1;

FIG. 3 is a side view of the surgical platform;

FIG. 4 is a partially exploded top perspective view of a portion of the surgical platform;

FIG. 5 is a top view of the surgical platform;

FIG. 6 is a front perspective view of the surgical platform;

FIG. 7 is a front view of the surgical platform;

FIG. 8 is a side view of the surgical platform;

FIG. 9 is a back view of the surgical platform in a folded position;

FIG. 10 is a top view of the surgical platform in a folded position;

FIG. 11 is a side perspective view of the surgical platform in a folded position;

FIG. 12 is a front perspective view of the surgical platform in a folded position;

FIG. 13 is a top view of the surgical platform in an extended position;

FIG. 14 is a top view of the surgical platform in an extended position in use;

FIG. 15 is a top view of the surgical platform in use;

FIG. 16 is a partially exploded front perspective view of a second embodiment of the surgical platform;

FIG. 17 is a front view of the second embodiment of the surgical platform;

FIG. 18 is a side cutaway view of the second embodiment of the surgical platform taken along line A-A;

FIG. 19 is a detailed view of a portion B of the side cutaway view of the second embodiment of the surgical platform;

FIG. 20 is an exploded back perspective view of the second embodiment of the surgical platform without the optional extension platform;

FIG. 21 is a side view of the second embodiment of the surgical platform;

FIG. 22 is a partially exploded top perspective view of a portion of the second embodiment of the surgical platform;

FIG. 23 is a front perspective view of the second embodiment of the surgical platform;

FIG. 24 is a top view of the second embodiment of the surgical platform;

FIG. 25 is a side view of the second embodiment of the surgical platform; and

FIG. 26 is a front view of the second embodiment of the surgical platform.

Other advantages and features will be apparent from the following description and from the claims.

### DETAILED DESCRIPTION OF THE INVENTION

The devices and methods discussed herein are merely illustrative of specific manners in which to make and use this invention and are not to be interpreted as limiting in scope.

While the devices and methods have been described with a certain degree of particularity, it is to be noted that many modifications may be made in the details of the construction and the arrangement of the devices and components without departing from the spirit and scope of this disclosure. It is understood that the devices and methods are not limited to the embodiments set forth herein for purposes of exemplification.

In general, in a first aspect, the invention relates to a stable surgical platform assembly. The assembly may comprise a platform 1 attached to a frame assembly 2, which may attach to a peg board 3 or other support, such as a surgical table clamp or a surgical table rail, for use.

The platform 1 may have a generally flat top. The platform 1 may be generally rectangular, as shown, or any other desired shape. The platform 1 may be any desired size. The platform 1 may be made of polyvinyl chloride or any other desired and appropriate material. In particular, the material of the platform 1 may be radiolucent. The platform 1 may be any desired thickness, provided it is thick enough to provide stability and thin enough to remain radiolucent.

The frame assembly 2 may support the platform 1 securely and stably. The frame assembly 2 may be capable of attachment to the peg board 3 or other support, such that the platform 1 is stable during use. The frame assembly 2 may be height adjustable.

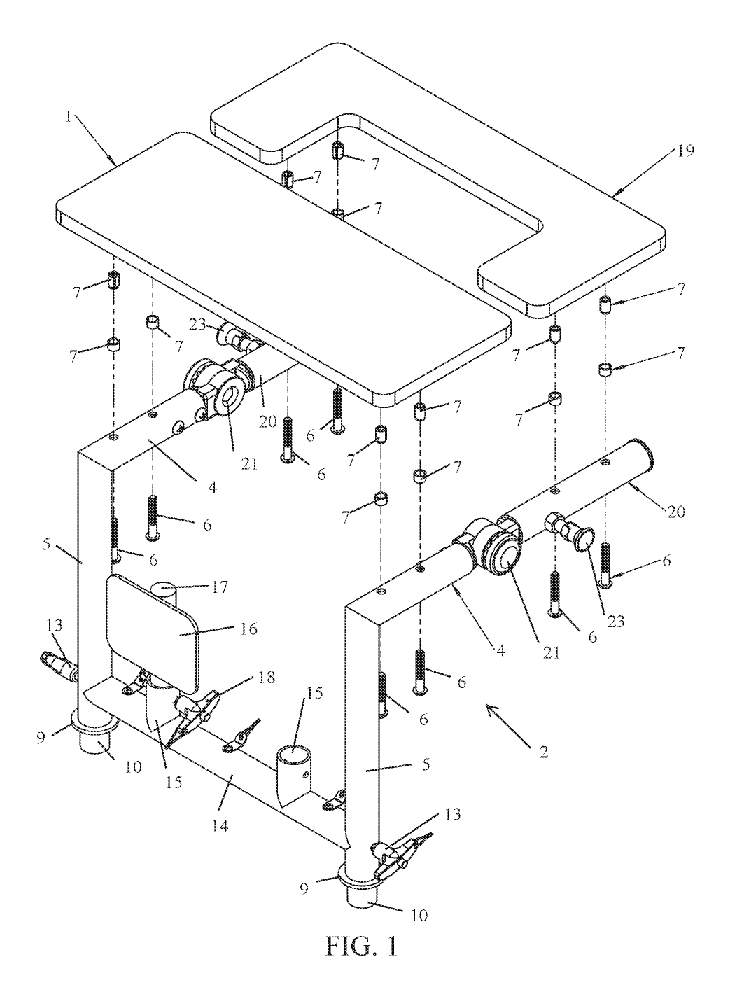

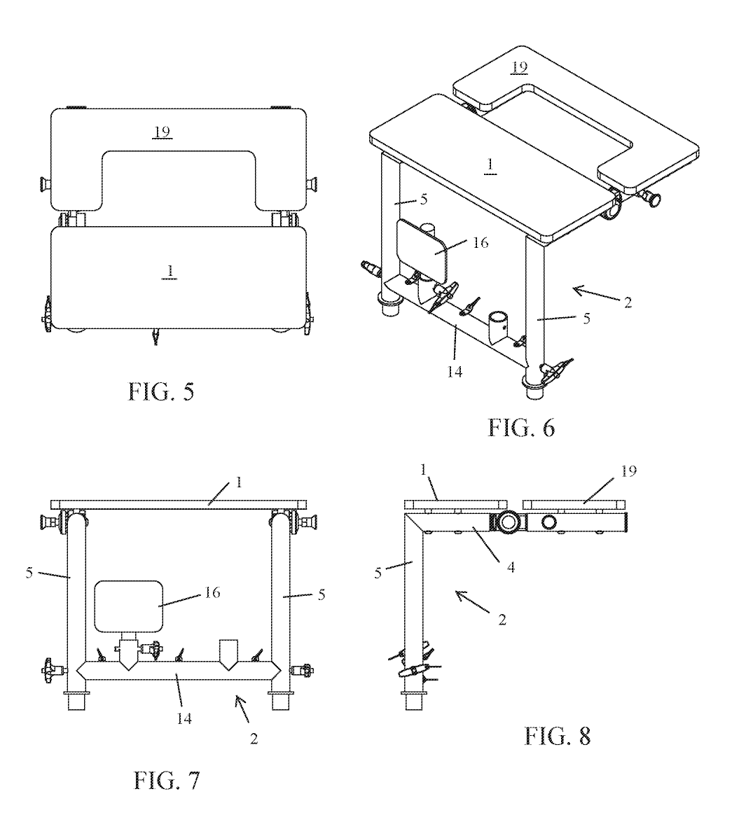

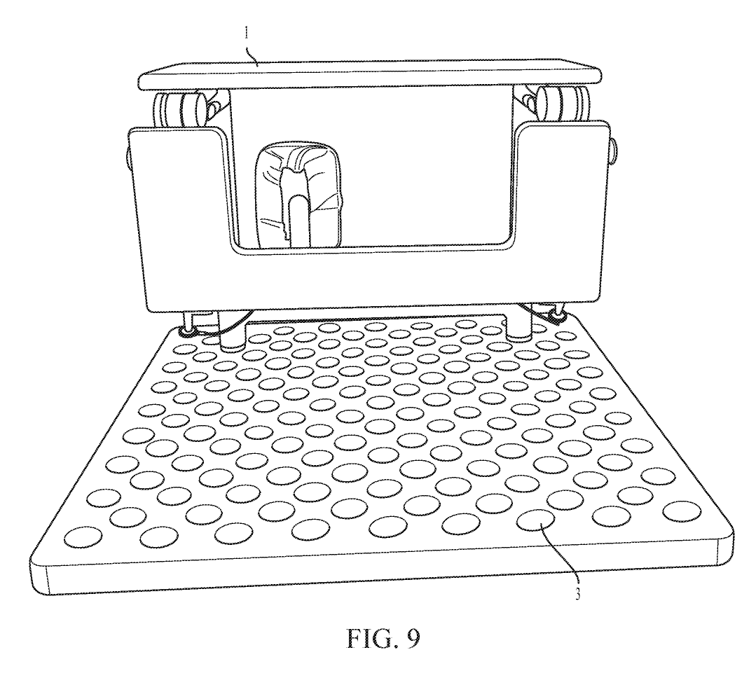

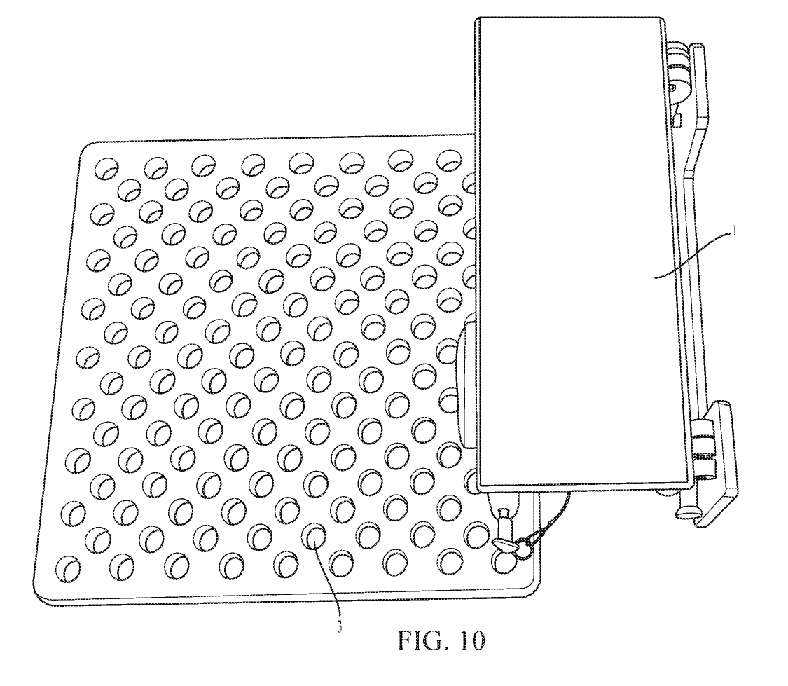

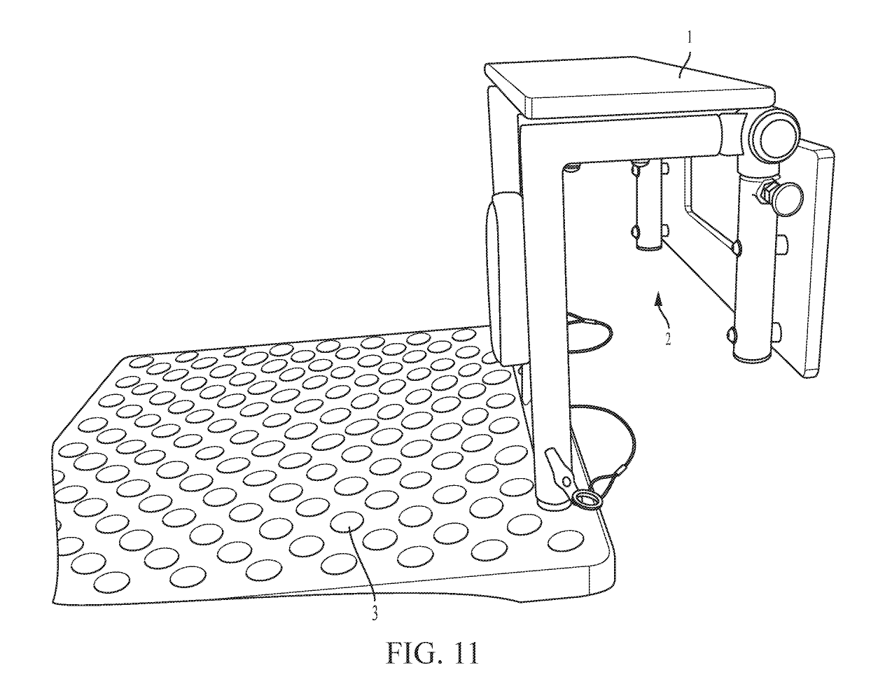

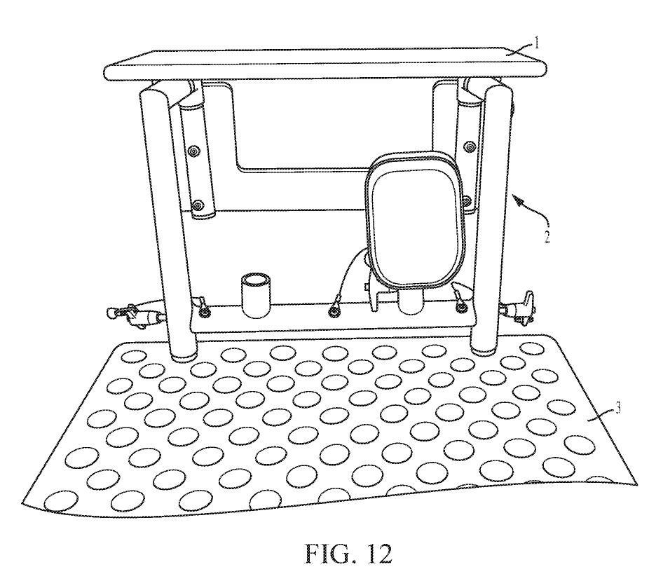

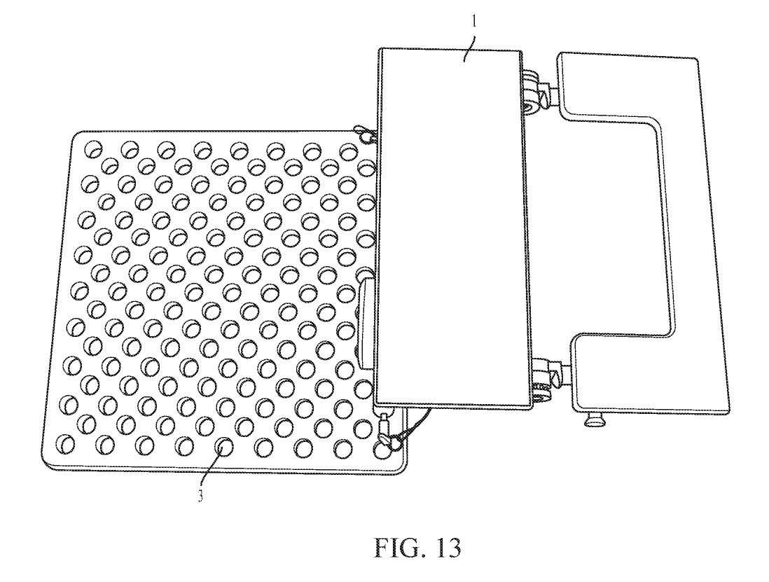

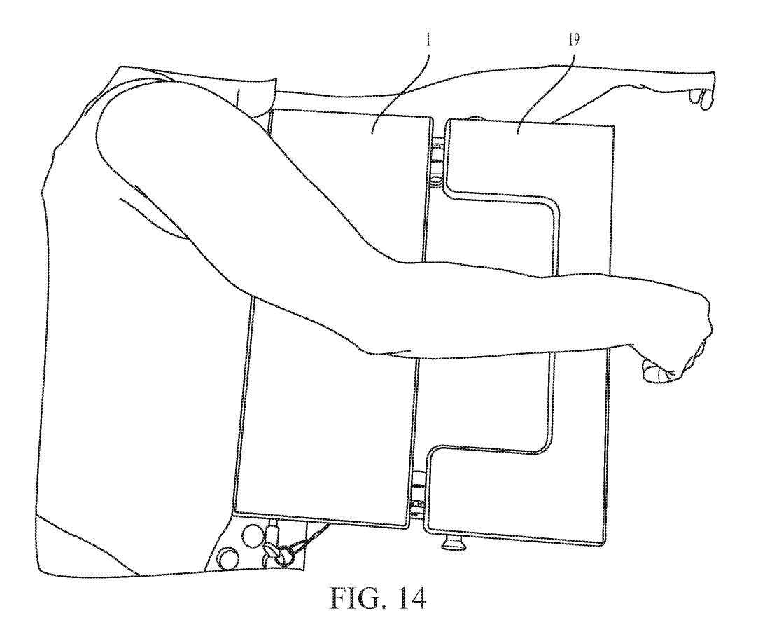

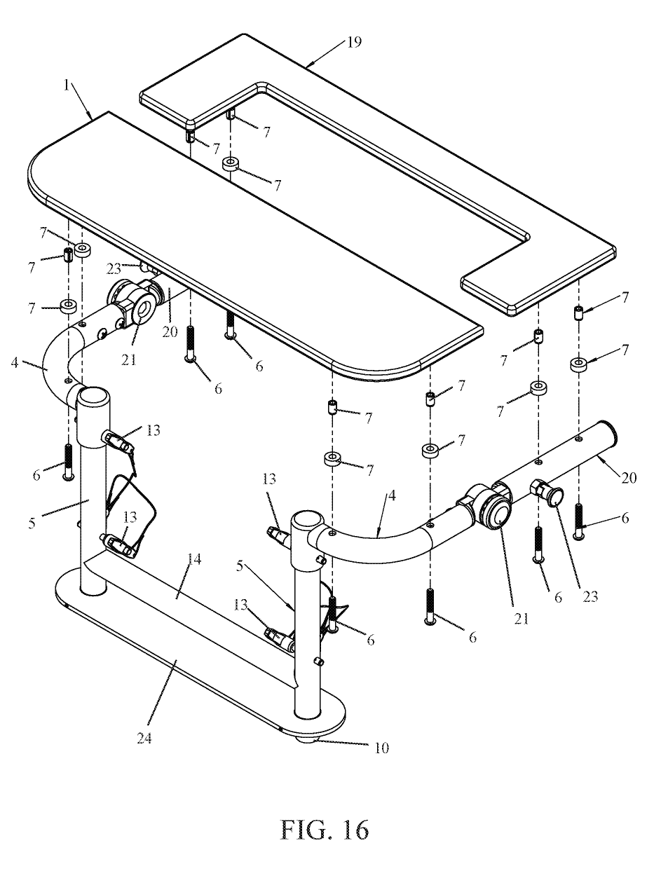

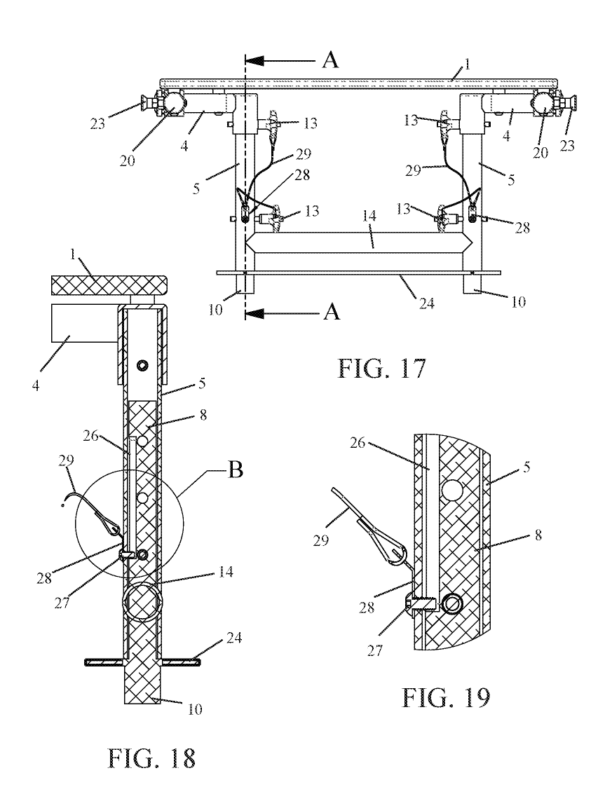

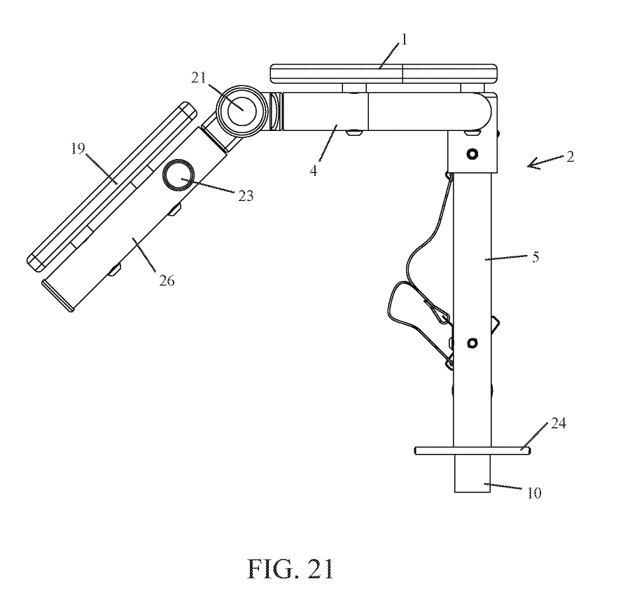

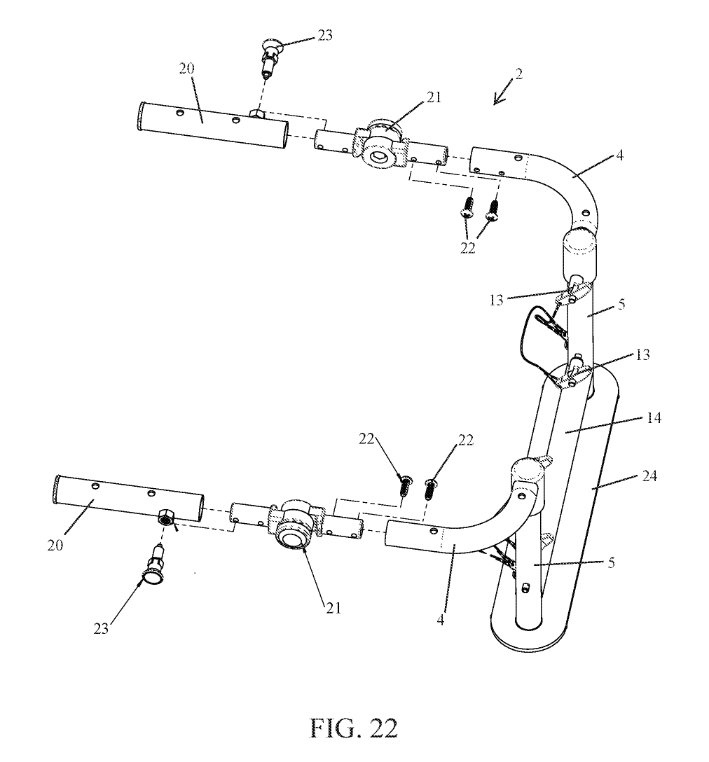

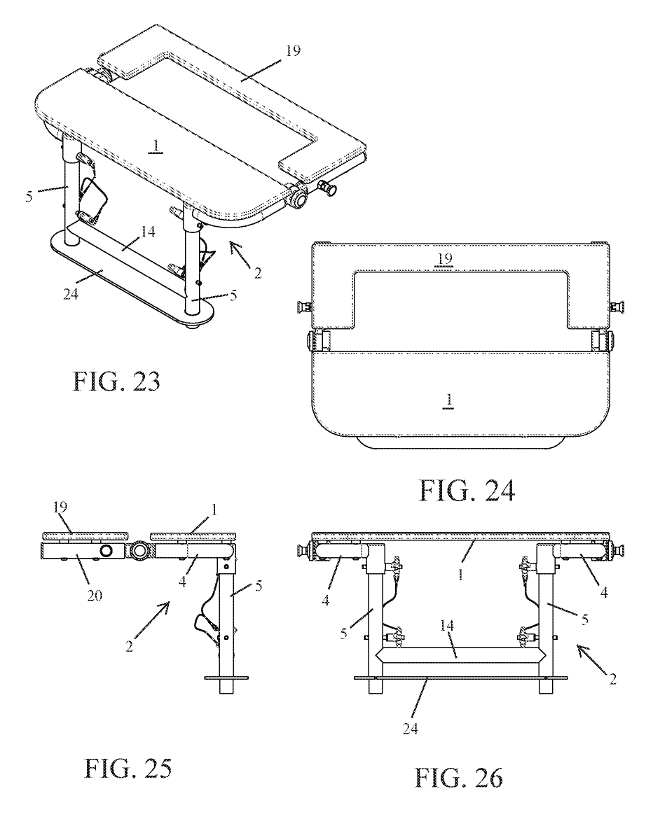

Specifically, the frame assembly 2 may comprise two parallel horizontal rails 4 and two parallel vertical rails 5, where the horizontal rails 4 connect on one end to the tops of the vertical rails 5. The horizontal rails 4 and vertical rails 5 may form two inverted-L-shaped supports, as shown in FIGS. 1 through 8. Alternately, the horizontal rails 4 and vertical rails 5 may each or jointly form a J-shape or a C-shape. For example, as shown in FIGS. 16 through 26, each of the rails 4 may be curved. Each rail 4 may connect on one end to the top of a vertical rail 5, projecting outwardly from the assembly to the side before curving back, such that the opposing end of the rail 4 projects to the back of the assembly, with the backs of the two rails 4 parallel to each other and perpendicular to the vertical rails 5, as shown. The horizontal rails 4 may be fixedly secured to or integrally formed with the vertical rails 5, as shown in FIGS. 1 through 8, or may be removably attached to the vertical rails 5, such as via attachment devices 13, as shown in FIGS. 16 through 26. This may allow the vertical rails 5 to be replaceable to support a variety of platforms 1 of various sizes. Indeed, the platform assembly may include a variety of sizes of platforms 1, such as 6″, 7″ and 8″ platforms or any other combination of sizes, which may be used interchangeably as needed.

The rails 4 and 5 may be generally tubular, as shown, or may have any other desired shape. In particular, the rails 4 and 5 may have any desired cross section. The rails 4 and 5 shown in the drawings have a circular cross section, but they could have a cross section that is square, rectangular, triangular, or any other shape. The rails 4 and 5 may be made of aluminum, which is fairly radiolucent, or may be made of any other desired and suitable material.

The platform 1 may attach to the tops of the parallel horizontal rails 4, as shown in FIG. 1. The platform 1 may attach in any manner desired. For example, the platform 1 may attach via one or more attachment devices 6, such as screws. The attachment devices 6 may extend from the bottoms of the rails 4, out their tops, and into the platform 1 from below. The attachment devices 6 may be sized such that they do not reach further than midway through the thickness of the platform 1, such that they do not break the top surface thereof, leaving the top surface smooth and intact. The platform 1 may be raised above the rails 4 via one or more nuts and/or spacers 7, as desired. Optionally, the platform 1 may be attached in such a way that it may slide and/or swivel relative to the frame assembly 2.

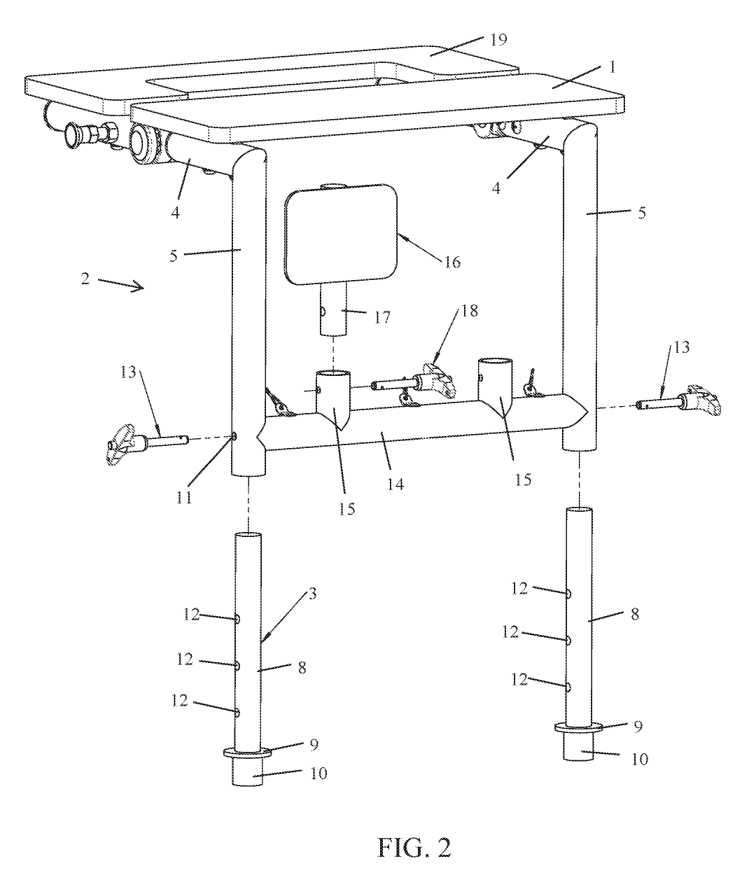

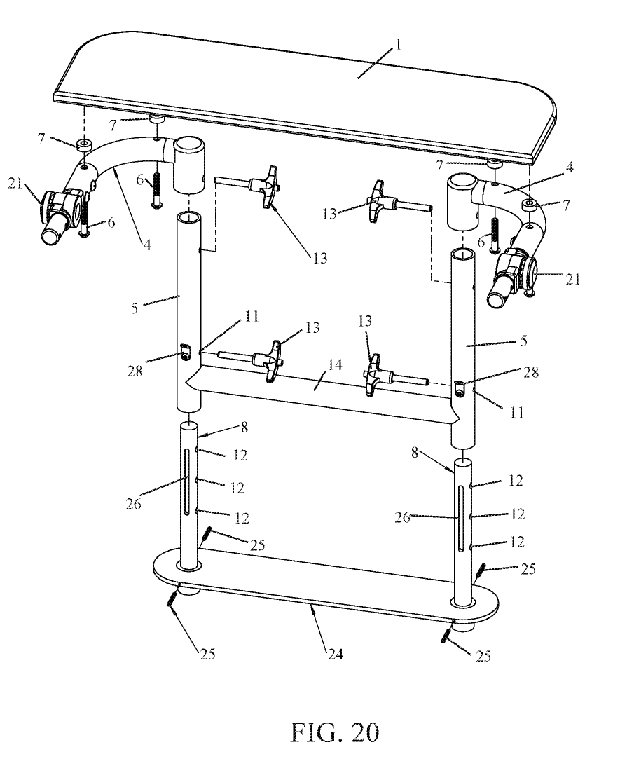

The lower end of the parallel vertical rails 5 may be appropriately sized for placement in a standard surgical peg board 3 or other support for use. As noted above, the rails 5 may have any desired cross section; if they are intended for placement in the peg board 3, however, at least the lower ends may have a round cross section, as a standard surgical peg board 3 has round holes. Alternately, the lower end of the parallel vertical rails 5 may attach to a separate structure that is be appropriately sized and shaped for placement in the peg board 3 or other support. The separate structure may additionally allow the frame assembly 2 to be height adjustable. For example, as shown in FIGS. 2 and 20, each of the parallel vertical rails 5 may have a nesting rail 8 that has a slightly smaller diameter than the inside diameter of the rails 5. The nesting rails 8 may fit within the rails 5, and may slide freely therein. A stop 9, such as a flange, may be located near the lower end 10 of each nesting rail 8, preventing the nesting rail 8 from going fully within its rail 5. Alternately, a platform 24 may extend between the two nesting rails 8 near the lower end 10 of each nesting rail 8, similarly functioning as a stop and preventing the nesting rails 8 from going fully within their rails 5 while also providing a surface for the user to push against to assist in height adjustment. The platform 24 may held in place via pegs or other attachment devices 25. The lower end 10 of each nesting rail 8 may be appropriately sized and shaped for placement in the peg board 3 or other support. In particular, the nesting rail 8 may have a circular cross section with a wider diameter than the rest of the nesting rail 8, potentially other than the stop 9 or platform 24; indeed, the lower end 10 may have the same or a similar diameter as its corresponding rail 5.

Each rail 5 may have a hole 11 near its lower end. Each nesting rail 8 may have a series of corresponding holes 12 along its length, such that one of the holes 12 may be aligned with the hole 11 and a peg, locking button spring clip, or other attachment device 13 may be inserted through the holes 11 and 12 to secure the nesting rail 8 at a particular height relative to the rail 5. Thus, the height of the frame assembly 2 may be adjusted by sliding each nesting rail 8 to a desired height, aligning one of the holes 12 with the hole 11, and securing the attachment device 13 therein, where both nesting rails 8 are secured at the same height. Each of the nesting rails 8 may have a slot 26, and each of the rails 5 may have a corresponding hole through which a screw 27 or other projecting device may extend, such that the screw 27 or other projecting device projects into the slot 26 when the frame assembly 2 is fully assembled. The combination of the slot 26 and screw 27 or other projecting device may function as a rail stop, limiting the extent to which the rail 5 may be moved relative to the nesting rail 8. This may aid the user in aligning hole 11 with the upper or lower hole 12. Optionally, the screw 27 or other projecting device may also attach a bracket 28 to the rail 5, to which one or more attachment devices 13 may be secured via a length of flexible wire 29 or other retention device so that the attachment devices 13 are not lost.

One or more supports 14 may extend between the two vertical rails 5. Specifically, a horizontal support 14 may extend between the vertical rails 5 near their bottoms, spaced from the horizontal rails 4. The horizontal support 14 may be located at the level of the hole 11, allowing the end of the attachment device 13 to lie within the support 14, or below the level of hole 11, allowing the attachment device 13 to be located directly above the support 14. One or more accessories may be attached to the support 14. For example, one or more vertical posts 15 may extend upward from the support 14 for accessory placement. One such accessory may be a sternal chest plate 16. The sternal chest plate 16 may have a post 17 that fits within one of the vertical posts 15 and is held in place with a pin or other attachment device 18.

The stable surgical platform assembly may include an extension for supporting the lower arm, when desired. The extension may be adjustable, allowing the arm to be held at any desired angle. The extension may have an adjustable length and/or width.

Specifically, the extension may include an extension platform 19. Like the platform 1, the extension platform 19 may be any desired size and shape. For example, the extension platform 19 may be C-shaped, as shown. The extension platform 19 may be made of polyvinyl chloride or any other desired and appropriate material. In particular, the material of the extension platform 19 may be radiolucent. The extension platform 19 may be any desired thickness, provided it is thick enough to provide stability and thin enough to remain radiolucent.

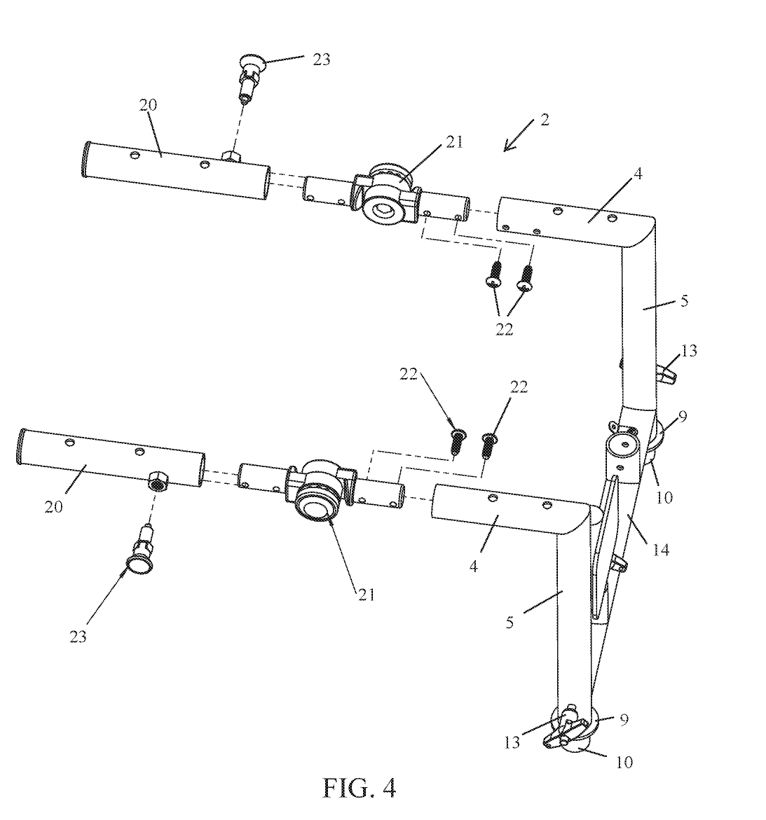

The extension platform 19 may be supported by the frame assembly 2. In particular, the extension platform 19 may be supported by extension rails 20, which may be connected to the horizontal rails 4 vial hinges 21, as shown in FIG. 4. The hinges 21 may be locking hinges. The hinges 21 may be secured to the horizontal rails 4 via screws or other attachment devices 22. The extension rails 20 may be removably secured to the hinges 21 via spring loaded pegs or other easily removable attachment devices 23, allowing the extension platform 19 to be quickly and easily removed from the stable surgical platform assembly when not in use.

The extension platform 19 may attach to the extension rails 20 via one or more attachment devices 6, such as screws. The attachment devices 6 may extend from the bottoms of the extension rails 20, out their tops, and into the extension platform 19 from below. The attachment devices 6 may be sized such that they do not reach further than midway through the thickness of the extension platform 19, such that they do not break the top surface thereof, leaving the top surface smooth and intact. The extension platform 19 may be raised above the extension rails 20 via one or more nuts and/or spacers 7, as desired.

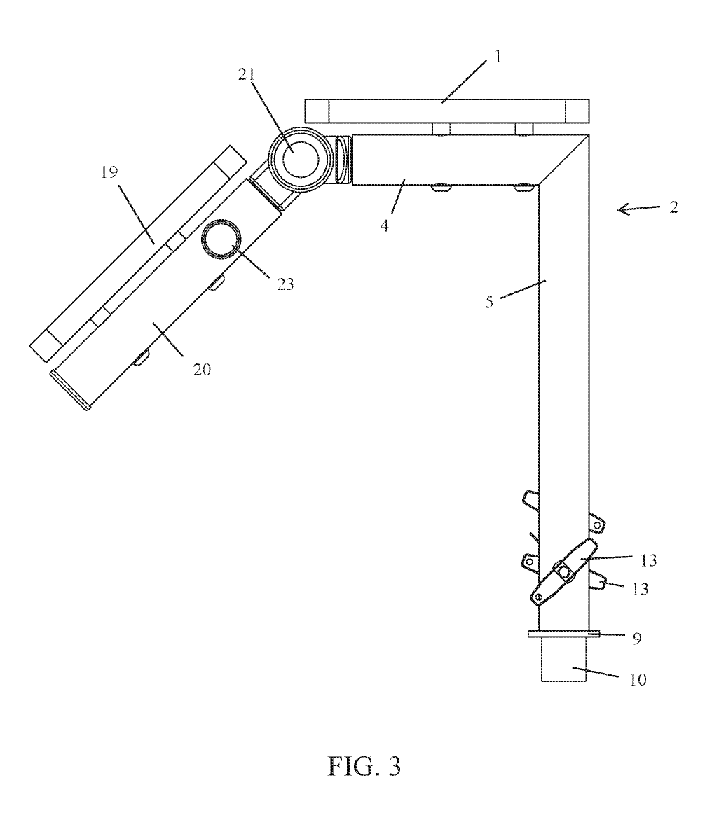

When fully extended, the extension rails 20 may align with the horizontal rails 4, as shown in FIG. 1, allowing the extension platform 19 to align with and lie in the same plane as the platform 1. The locking hinges 21 may allow the extension platform 19 to be set at any desired angle, as shown in FIG. 3. The removable attachment devices 23 may allow the extension platform 19 to be removed as desired.

The extension may include one or more additional features. For example, a piece may be added to the extension platform 19 that allows the application of traction through the patient's wrist.

The platform 1 may be topped by a pad, which may be made of a low-density memory foam or other desired padding, either with or without a cover made from the same or a different material. A similar pad may cover the top of the extension platform 19 and/or the sternal chest plate 16. All materials of the pads may be such that the pads do not make a radiographic shadow. The pads may be edged in elastic or an elastic material, similar to a shower cap, such that the pad may cover the top of the platform 1, the top of the extension platform 19, or the sternal chest plate 16, as appropriate, with the edge held underneath in a secure or semi-secure manner by the elastic or elastic material. Alternately, the pads may be permanently or temporarily secured to the stable surgical platform assembly by any other desired attachment device or devices or manner. The pads may be disposable and may be intended for single use. Additionally or alternately, padding may be located on the vertical rails 5, the support rail 14, the nesting rails 8, and/or any other component of the stable surgical platform assembly as desired. This padding may be permanently or temporarily secured to the stable surgical platform assembly by any desired attachment device or devices or manner. This padding may be disposable and may be intended for single use. For example, the padding may be tubular with a longitudinal slit, such that it may be opened along the slit, placed over a portion of one of the rails 5, 8, or 14, and released to temporarily cover the rail.

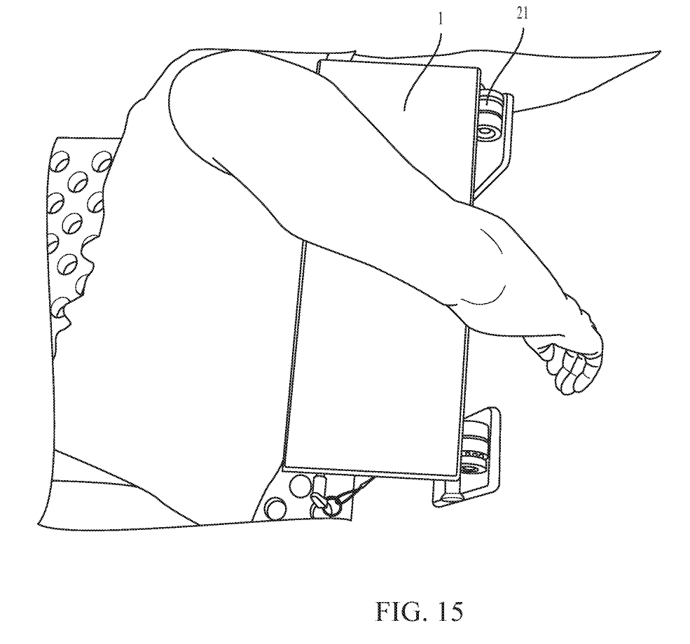

During use, a peg board 3 may be clamped to a surgical table, with a gel foam topper placed on top. The lower ends 10 of the nesting rails 8 may be placed in holes in the peg board 3. Removable pads may be placed on the platform 1, the extension platform 19, the sternal chest plate 16, the vertical rails 5, the nesting rails 8, and/or the support rail 14. The patient may be placed in a lateral position on the surgical table, with the patient's chest resting against the sternal chest plate 16, if in use, or against the padded vertical rails 5, and the patient's upper arm resting on the platform 1. The patient's lower arm may extend outward above the stable surgical platform assembly, as shown in FIG. 15. Depending on which side is being used, the sternal chest plate 16 may have been placed in the appropriate vertical post 15. Depending on the height of the patient's shoulder when in the lateral position, the height of the stable surgical platform assembly may be altered by removing the attachment devices 13, sliding the vertical rails 5 upward or downward to a desired position with holes 11 aligning with one set of holes 12, and replacing attachment devices 13. The angle of the extension platform 19 may be changed, as desired, or the extension platform 19 may be removed if it is not needed.

The stable surgical platform assembly may be particularly useful for fixation of upper extremity trauma, including surgeries involving the humerus, elbow, proximal radius, and/or proximal ulna. The stable surgical platform assembly may also be useful as an arm positioner during other types of surgeries, such as during a thoracotomy, surgery on the latissimus flaps, posterior scapula surgery, and/or others.

Whereas, the devices and methods have been described in relation to the drawings and claims, it should be understood that other and further modifications, apart from those shown or suggested herein, may be made within the spirit and scope of this invention.

What is claimed is:

1. A surgical platform assembly comprising:
a platform capable of stably supporting an upper arm of a patient; and
a frame assembly, where the platform is attached to and stably supported by the frame assembly.

2. The surgical platform assembly of claim 1 where the platform has a flat top.

3. The surgical platform assembly of claim 1 where the platform is radiolucent.

4. The surgical platform assembly of claim 1 where the frame assembly is capable of being stably supported by a surgical peg board.

5. The surgical platform assembly of claim 1 where the frame assembly is height adjustable.

6. The surgical platform assembly of claim 1 where the frame assembly comprises:
two parallel horizontal rails, where the platform rests upon and is attached to and supported in a horizontal position by the two parallel horizontal rails; and
two parallel vertical rails, where each of the vertical rails has an upper end connected to a first end of one of the horizontal rails, such that the two parallel horizontal rails and the two parallel vertical rails form two parallel inverted-L, C, or J-shaped supports.

7. The surgical platform assembly of claim 6 where each of the two parallel horizontal rails and each of the two parallel vertical rails are generally tubular.

8. The surgical platform assembly of claim 6, the frame assembly further comprising two nesting rails, where each of the nesting rails fits slidably within and is generally coaxial with one of the vertical rails, such that the nesting rails are capable of sliding in and out of a lower end of the vertical rails and being secured thereto at a desired position to alter the height of the surgical platform assembly.

9. The surgical platform assembly of claim 8, each of the nesting rails further comprising:
a stop located on the nesting rail, where the stop is capable of preventing the nesting rail from sliding fully within its corresponding vertical rail; and
a lower end capable of fitting within a hole in a surgical peg board.

10. The surgical platform assembly of claim 8, the frame assembly further comprising:
a lateral hole in each of the vertical rails;
one or more corresponding lateral holes in each of the nesting rails; and
two pegs, where each peg is capable of being inserted through the hole in one of the vertical rails and through one of the holes in one of the nesting rails to secure the nesting rail in a particular position relative to the vertical rail.

11. The surgical platform assembly of claim 6 further comprising a horizontal support extending between the two parallel vertical rails.

12. The surgical platform assembly of claim 11 where the horizontal support is radiolucent, adjustable, capable of sliding, capable of swiveling, or any combination thereof.

13. The surgical platform assembly of claim 11 further comprising a sternal chest plate removably mounted on the horizontal support.

14. The surgical platform assembly of claim 13 further comprising a plurality of mounting points for removably mounting the sternal chest plate to the horizontal support in a desired position.

15. The surgical platform assembly of claim 1 further comprising an extension platform capable of stably supporting a lower arm of the patient, where the extension platform is attached to and stably supported by the frame assembly.

16. The surgical platform assembly of claim 15 where the frame assembly comprises one or more hinges capable of altering the angle of the extension platform relative to the platform.

17. The surgical platform assembly of claim 15 where the extension platform is removable.

18. The surgical platform assembly of claim 17 further comprising one or more replacement extension platforms.

19. The surgical platform assembly of claim 15 where the extension platform is radiolucent.

20. The surgical platform assembly of claim 1 further comprising one or more pads.

21. The surgical platform assembly of claim 19 where the pads are removable, disposable, and intended for one-time use.
